(19) United States
(12) Patent Application Publication
(10) Pub. No.: US 2012/0324516 A1
(43) Pub. Date: Dec. 20, 2012

(54) METHOD AND SYSTEM TO PROVIDE A CONSUMER ELECTRONICS SYSTEM WITH IMPROVED FUNCTIONALITY

(75) Inventor: Itamar GOLD-GAVRIELY, Sunnyvale, CA (US)

(73) Assignee: MEDIATEK SINGAPORE PTE. LTD., Singapore (SG)

(21) Appl. No.: 13/289,976

(22) Filed: Nov. 4, 2011

Related U.S. Application Data
(60) Provisional application No. 61/496,576, filed on Jun. 14, 2011.

(51) Int. Cl. H04N 21/436

(52) U.S. Cl. 725/81; 725/78

(57) ABSTRACT

A method and system to provide networking related features and other features to a consumer electronics system. The system implementation described herein shows one option to implement the method for a DTV system. The system includes a router and a DTV System-on-a-Chip. The router provides features to the DTV when the DTV system can be in any mode including on and stand-by, features like Access Point, WiFi Direct, Network Storage, Ethernet Switch and Network Pre-fetch.

### CROSS-REFERENCE TO RELATED APPLICATION

The present application claims the benefit of U.S. Provisional Application No. 61/496,576, filed on Jun. 14, 2011, entitled “METHOD AND SYSTEM TO PROVIDE A DIGITAL TELEVISION (DTV) WITH IMPROVED FUNCTIONALITY,” which is incorporated herein by reference in its entirety.

### FIELD OF THE INVENTION

The present invention relates generally to consumer electronics system and more particularly to providing a consumer electronics system with improved functionality.

### BACKGROUND OF THE INVENTION

In the digital television (DTV) environment, there are a variety of features that can be enabled and accessed. However, there is still untapped potential when utilizing a digital television in a variety of environments. What is needed is a system and method that address this untapped potential. Accordingly, the present invention addresses such a need.

### SUMMARY OF THE INVENTION

Aspects of the present invention are directed to the features provided by a network connected system and a router system, and more particularly to a system and method of providing router features and other features to a consumer electronics system.

The present invention comprises a method and apparatus so that wireless and wired router features, as well as other enhanced features, can be added to a network connected consumer electronics device.

The present invention has applications in a network connected consumer electronics consumer space. The present invention will allow the consumer electronics system to work in a legacy old mode as well as with the features of the present invention.

A method and system in accordance with the present invention is provided to allow networking related features and other features to be connected to a network connected device.

In a first aspect, a consumer electronics system comprises a consumer electronics System-on-a-Chip (SoC) and a networking chip integrated with the consumer electronics SoC. The consumer electronics system acts as an access point (AP).

In a second aspect, a consumer electronics system comprises a consumer electronics System-on-a-Chip (SoC) and a networking chip integrated with the consumer electronics SoC. The consumer electronics system in standby mode provides fully functional wireless capabilities.

In a third aspect, a consumer electronics system comprises a consumer electronics System-on-a-Chip (SoC) and networking chip integrated with the consumer electronics SoC, wherein the consumer electronics system in standby mode provides fully functional wired switching capability.

A system and method in accordance with the present invention can provide networking features like WiFi Direct, Network Storage, Ethernet Switch and Network Pre-Fetch as well as providing access to a plurality of other devices in a network.

### BRIEF DESCRIPTION OF THE DRAWINGS

FIG. 1 is an example of CE-HUB implementation for digital television (DTV), where the CE-Hub and DTV SoC are coupled together through an interface.

FIG. 2 is a system diagram which illustrates utilizing a DTV as an Access Point (AP).

FIG. 3 is a flow chart which illustrates utilizing a DTV as an AP.

FIG. 4 is a flow chart which illustrates utilizing a DTV in WiFi direct mode.

FIG. 5 is a flow chart which illustrates utilizing a DTV in a Wake On application.

FIG. 6 is a flow chart which illustrates connecting the DTV via a wireless display.

FIG. 7 is an example of a DTV Attached Storage Access system diagram.

FIG. 8 is a flowchart which illustrates utilizing a DTV attached storage access.

FIG. 9 is a system diagram which illustrates a DTV Ethernet Switch.

FIG. 10 is a flowchart which illustrates utilizing a DTV as an Ethernet Switch.

FIG. 11 is a system diagram which illustrates a DTV Pre-fetch system.

FIG. 12 is a flowchart which illustrates utilizing the DTV Pre-fetch mode.

### DETAILED DESCRIPTION

The present invention relates generally to a consumer electronics system and more particularly to providing a consumer electronics system with improved functionality. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiments shown, but is to be accorded the widest scope consistent with the principles and features described herein.

The present invention provides a method and apparatus to allow wireless and wired router features, as well as other enhanced features, to be added to a network connected consumer electronics device.

Consumer electronic systems such as digital televisions (DTV) are utilized in a variety of ways. However there additional uses that have not been realized as of today. Only a limited number of applications had primitive wake up capabilities based on Wake Up on WLAN and Wake Up on LAN.

Also, the DTV today does not negotiate with the wireless display source or a relevant network application on how to switch to the right DTV mode for the specific display requirement (game mode, video mode, cinema mode, etc.) In addition, a user does not have access to external data storage while attached to the DTV in stand-by mode unless an external Ethernet switch is attached and the external data storage is attached to the Ethernet switch. The Ethernet switch adds complexity and extra cost to the DTV. Also, home network devices will get access to the data only when the DTV would wake up and make the storage data available to the network, which is power consuming. Accordingly, what is desired is a consumer electronics architecture that addresses the above identified issues.

The present invention enhances the networking experience by adding networking features and networking-consumer electronics synergistic features to a consumer electronics system, including any mode. What is meant by any mode is where there is at least some functionality in the consumer electronics system. Examples of modes include but are not limited to operational mode, standby mode, or any other mode of operation. Systems and methods in accordance with embodiments will be described in the context of DTV system-on-a-chip (SoC) and consumer electronics (CE)-Hub implementations. What is meant by a CE Hub is a networking chip with associated software. However, the present invention is not so limited and a plurality of networking/consumer electronics features in various configurations could be utilized and those configurations would be with in the spirit and scope of the present invention. For example, the configurations include but are not limited to Set-Top-Box SoC and CE-Hub or Blu-Ray Player SoC and CE Hub or the like. Furthermore some of the networking enhancements can also be achieved with a software Access Point (softAP) whereas the networking hardware provided by the networking chip and the networking software runs on the consumer electronics SoC. With a softAP implementation the consumer electronics system will need a special operation mode to provide the enhanced features keeping the consumer electronics SoC in operational mode and not in standby mode. To describe the features of the present invention in conjunction with a particular example refer now to the following description in conjunction with the accompanying figures.

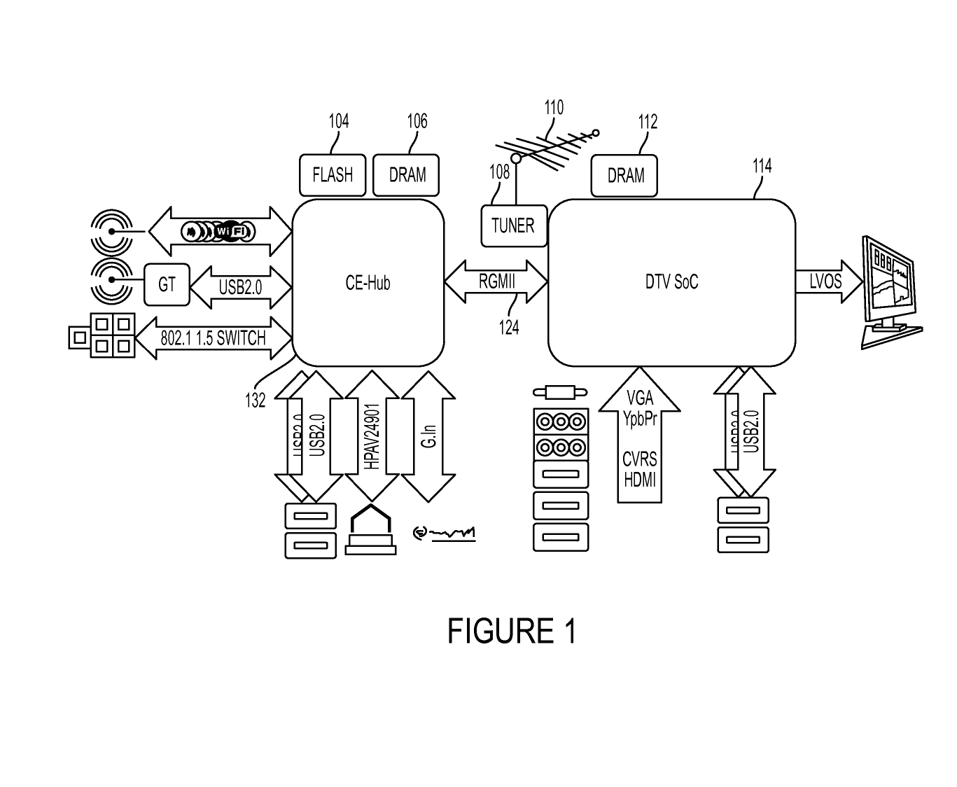

FIG. 1 is an example of CE-Hub implementation for a digital television (DTV), where the CE-Hub 132 and DTV System on a Chip (SoC) 114 are coupled together through an interface. This interface can be a RGMII interface 124, a USB or any other interface that will be able to transfer information adequately from the CE-Hub 132 to the DTV (SoC) 114 and vice versa. The CE-Hub 132 can be coupled to any or any combination of a DRAM 106, and a Flash memory 104. It can also include a plurality of connectors for various functions including WiFi, switching and the like. The CE-Hub 132 is coupled to a DTV System on a Chip (SoC) 114. The SoC 114 is coupled to a tuner 108 and antenna 110, and also includes a plurality of connectors for various interfaces. CE-Hub 132 may have the Flash memory 104 attached to it which provides the data to the DTV SoC 114 during boot up time or in other modes.

Today connectivity ports are in different states of integration. Some are integrated into the SOC 114, some are on the main board, and some are in add-on modules. CE-Hub 132 can include all connectivity in its one sub system, so the SOC 114 interface is united, for example, using RGMII 124, USB or some other interface. It reduces the complexity of the system and assures interoperability between different systems that use the CE-Hub 132 subsystem.

The CE-Hub 132 brings advanced features to the DTV system in four major areas: (1) connectivity hub, (2) Wake on IP Application request, (3) home network enhancement, and (4) IP Pre-Fetch. Each of these features is described in detail hereinbelow.

To describe the features of the present invention in more detail refer now to the following description in conjunction with the accompanying Figures. By combining the router with a digital television there are significant synergistic benefits that are provided when using such a combination. To describe these benefits refer now to the following description.

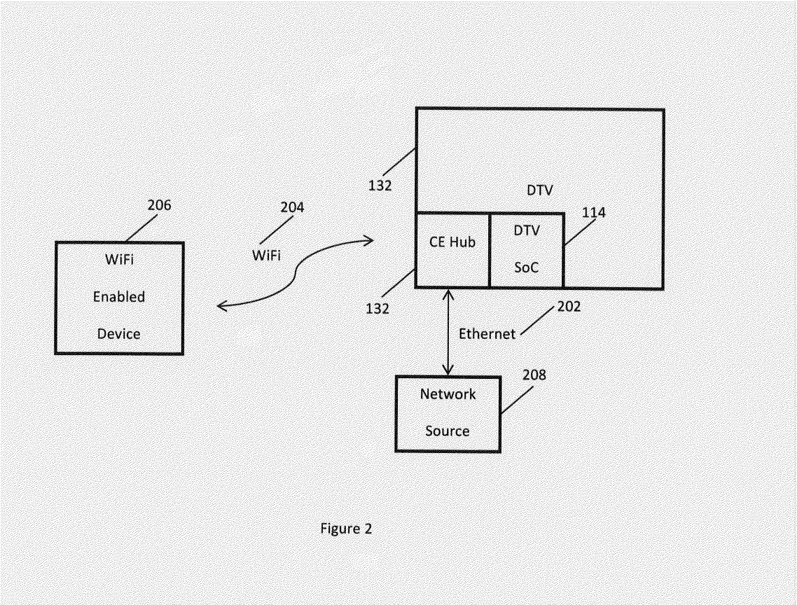

FIG. 2 is a system diagram which illustrates utilizing a DTV 208 as an Access Point (AP). As is seen, the DTV 208 includes a CE-Hub 132 integrated with the DTV SOC 114. What is meant by integrated is that the DTV SoC 114 can be combined with the CE-Hub in any manner to provide the improved functionality. For example, each of the DTV SoC and the CE-Hub could have separate SoCs that are coupled together, or the functionality could be combined on a single SOC. One of ordinary skill in the art readily recognizes that the DTV SoC 114 and the CE-Hub 132 could be combined in a variety of ways within the DTV 208 and that would still be within the spirit and scope of the present invention. The CE-Hub 132 will include connectivity features like Ethernet 802.3 port or ports 202 (may include a switch), GbE, WiFi 802.11 204, USB (2.0, 3.0, or others if applicable), Bluetooth, HPAV2.0/IEEE1901, G.hn, etc. As is known, the CE-Hub is always on if the DTV is configured to provide that functionality. Hence, when utilizing the DTV 200 as an AP mode the CE-Hub 132 remains on even when the DTV 208 is in stand-by mode or any other non-fully operational mode. The system 200 includes a Wi-Fi enabled device 206 which receives wireless signals from DTV 208, and a network source 208, which is coupled to the DTV 208 via an Ethernet cable 202. Thus, the DTV 208 can be in the stand-by mode, and still provide wireless network coverage, since the CE-Hub 132 is still enabled.

The CE-Hub 132 provides hot spot functionality from the DTV system 208 and thus enhances the home network experience. Using the Ethernet connection, CE-Hub 132 can provide the wireless router functionality. The consumer will have a better network experience in the house.

This technology applies to any Internet connected consumer electronics devices, but it can be extended to any network connected device with any networking technology.

To describe different modes of operation of this system refer to the following.

### AP Mode

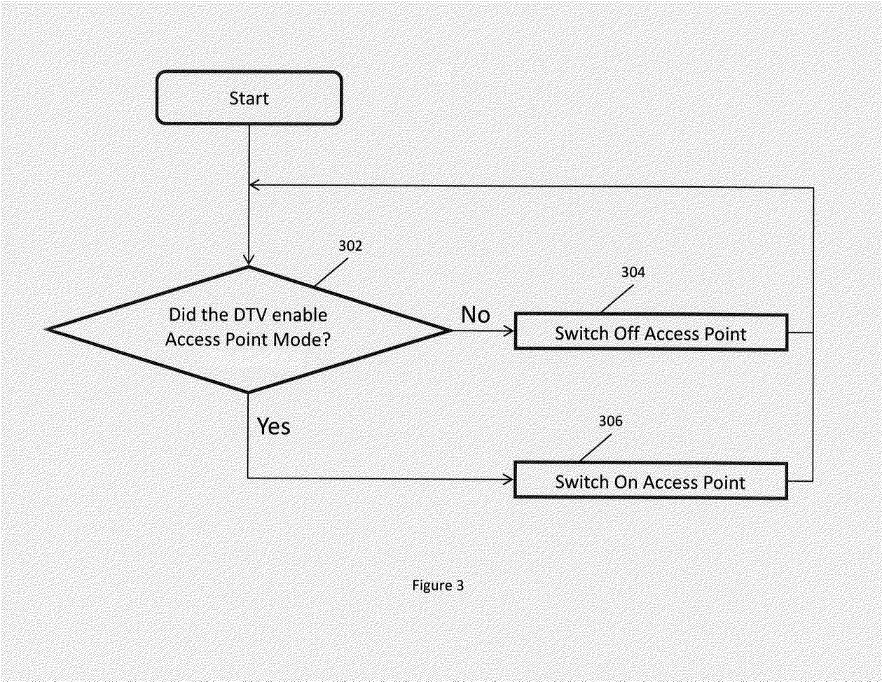

FIG. 3 is a flow chart which illustrates utilizing DTV 208 as an AP. Referring to FIGS. 2 and 3 together, first it is determined if the AP mode is enabled, via step 302. If the AP mode is enabled, turn on the AP, via step 306. The AP mode can remain on even if the DTV 208 is in stand-by mode. If the AP mode is not enabled, then turn off the AP, via step 304 and return.

DTV WiFi Direct mode

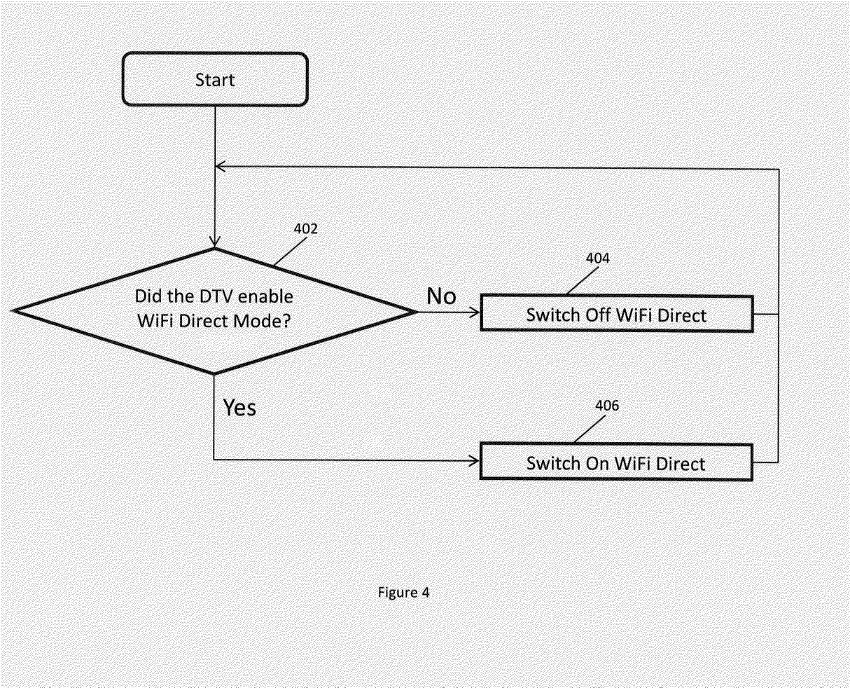

FIG. 4 is a flow chart which illustrates utilizing the DTV 208 in a WiFi direct mode. Referring to FIGS. 2 and 4, first it is determined if the WiFi direct mode is enabled, via step 402. If WiFi direct mode is enabled, turn on WiFi direct mode, via step 406. The WiFi direct mode can remain on even if the DTV 208 is in stand-by mode. If the WiFi direct mode is not enabled then turn off WiFi direct mode, via step 404 and return.

### Wake Up on Application

Today's Wake On wireless LAN and Wake On LAN are based on specific packets that went to the system to wake it up. There is no specific DTV system configuration option per application. The Advanced DTV wake up will make sure to wake up the DTV 208 to the right mode of operation, e.g., game mode, movie mode or the like.

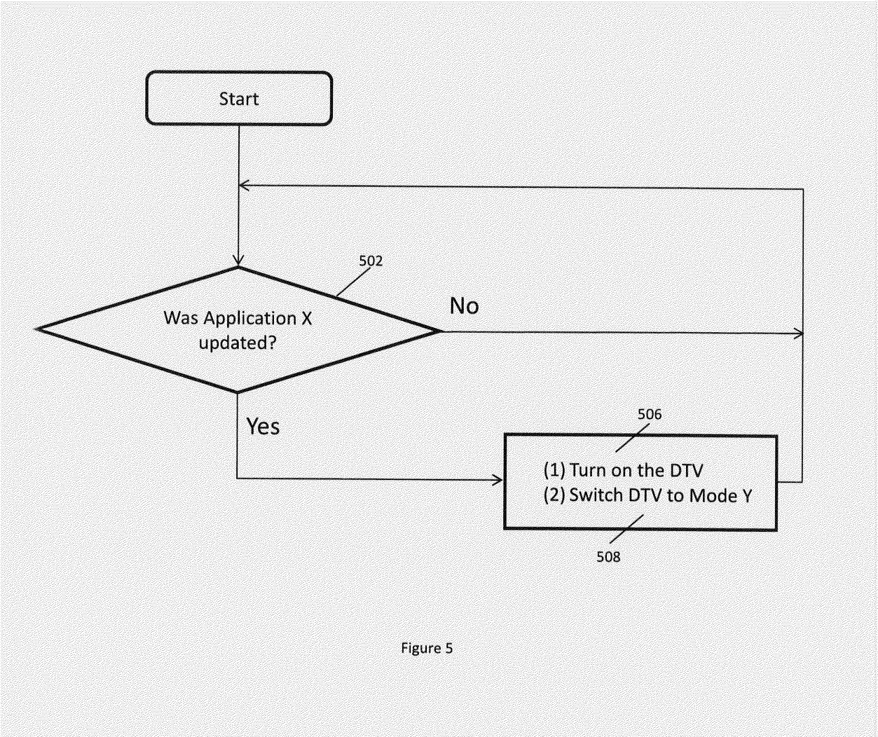

FIG. 5 is a flow chart which illustrates utilizing the DTV 208 in a Wake On application. Referring to FIGS. 2 and 5 together, first it is determined if the application is updated, via step 502. If application is updated then turn on DTV 208 and switch DTV 208 to a preferred mode, via step 508. The preferred mode comprises the mode 508 that is best for the application. If the application is not updated then return. The mode can be a display mode, an audio mode or a combination thereof that is best for the particular application.

An example of an implementation of this is a game mode for wireless display showing a game running on a PC with the DTV 208 as the display. The DTV 208 needs to be in game mode for minimal response time.

In conventional systems the user had to connect through VGA cable or through a wireless display feature. Below are the steps that would need to be taken if the DTV is to be in the game mode utilizing a conventional DTV.

### Connect Through VGA Cable:

1. Connect the VGA cable between the PC and TV.

2. Then, using the remote control, power on the TV.

3. Select the source mode.

4. Select VGA.

5. Then exit the source menu.

6. Select the display mode, and

7. select game mode, and

8. Exit the menu.

### DTV Wireless Display Feature

Connect through regular Wireless Display:

1. First, click on the PC wake up application (or Wireless Display button) that wakes up the TV using the WiFi magic packet (Wake On Wireless LAN).

2. Then, using the remote control,

a. select the display mode,

b. select game mode, and

c. then exit menu.

By contrast, when utilizing a system in accordance with the present invention, when the TV needs to be in the game mode:

### Connect Through CE-Hub Wireless Display:

Click on The PC wake up application (or Wireless Display button) that wakes up the TV with game mode on.

Accordingly, a system and method in accordance with the present invention is more simple and direct than the conventional mechanisms. The same feature can be utilized when a movie or photos are being viewed. For example when in select movie mode when DTV wakes up for new movie title. The same feature can be utilized when for example a movie or photos are being viewed. For example, in picture frame mode, a photo album can be updated.

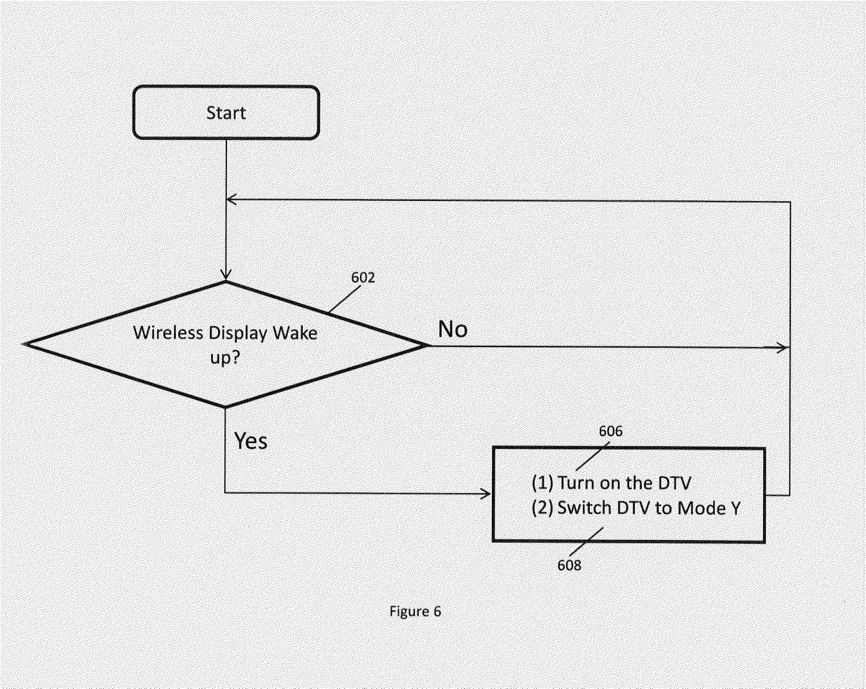

FIG. 6 is a flow chart which illustrates connecting the DTV 208 via a wireless display. Referring to FIGS. 2 and 6 together, first it is determined if a wireless display wake up is on, via step 602. If the wireless display wake up is on then turn on AP 200/turn on the DTV, via step 606/and switch DTV 208 to a preferred mode 608, via step 606. The preferred mode comprises the display mode and audio mode that has the best application for the wireless display source. If the wireless display wake up 604 is not on, then return.

### DTV Attached Storage Feature

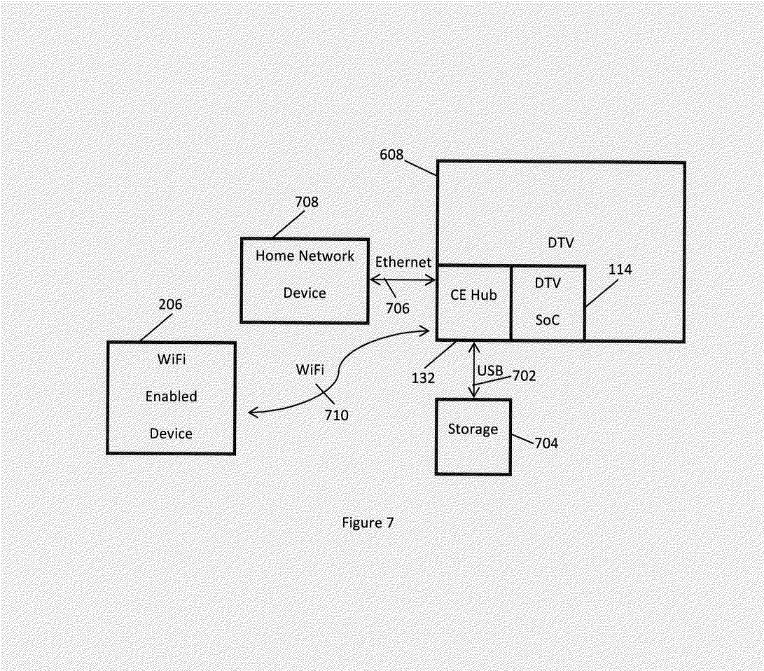

FIG. 7 is a system diagram which illustrates an attached storage access system to the DTV 208.

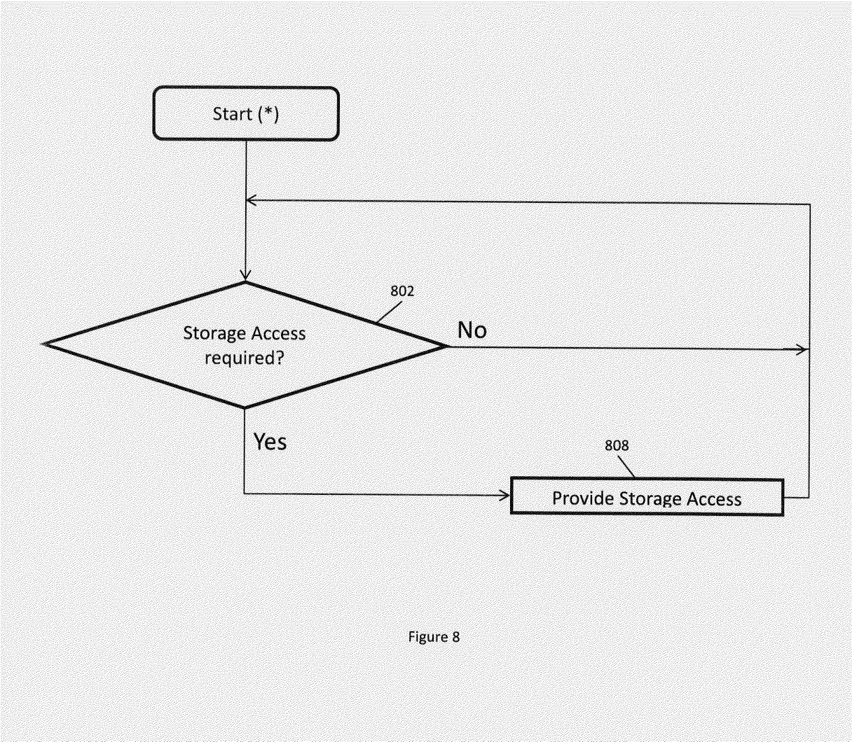

The DTV 208 is coupled to a home network device via Ethernet 706 and a storage device 704 via a connector 702 FIG. 8 is a flowchart which illustrates utilizing a DTV attached storage access. Referring to FIGS. 7 and 8 together, first it is determined that storage access is required, via step 802. If storage access is required, then provide storage access, via step 808. If storage access is not required, then return. Starting this process can occur regardless if the DTV 208 is in stand-by mode or not.

### DTV Ethernet Switch System Diagram

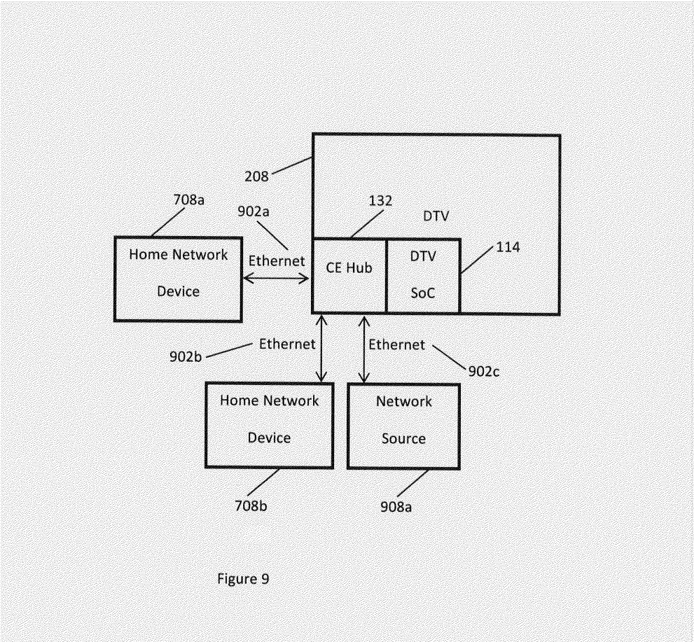

FIG. 9 is a system diagram which illustrates a DTV Ethernet Switch. The DTV 208 is coupled to home network devices 708a and 708b via an Ethernet cable 902a and 902b. The DTV 208 is coupled to a network source 908 via an Ethernet cable 902c.

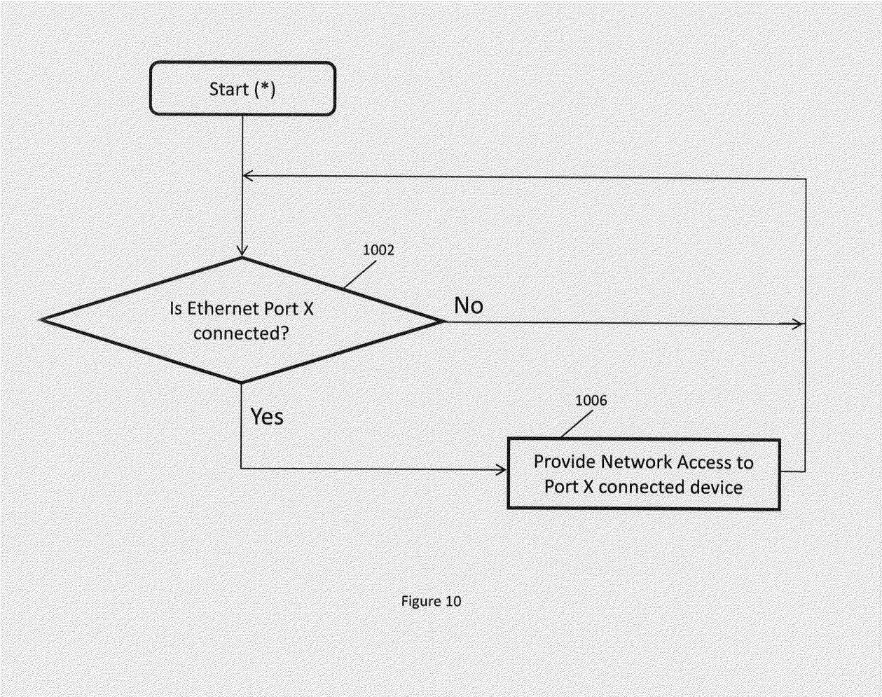

FIG. 10 is a flowchart which illustrates utilizing a DTV 208 as an Ethernet Switch. Referring to FIGS. 9 and 10 together, first it is determined if the Ethernet port is connected, via step 1002. If the Ethernet port X is connected, network access to port X is provided, via step 1002. If the network access to port X is not connected to the connected device, then return.

### DTV Pre-Fetch Feature

Today's Internet applications tend to require thin client thus relying on fast data transfer capabilities. CE-Hub adds pre-fetch to the DTV system so the data required for the application right after TV boot up time is immediately available. Pre-fetch functionality is aimed to improve the TV user experience when turning on the TV, expecting that the IP application will run immediately.

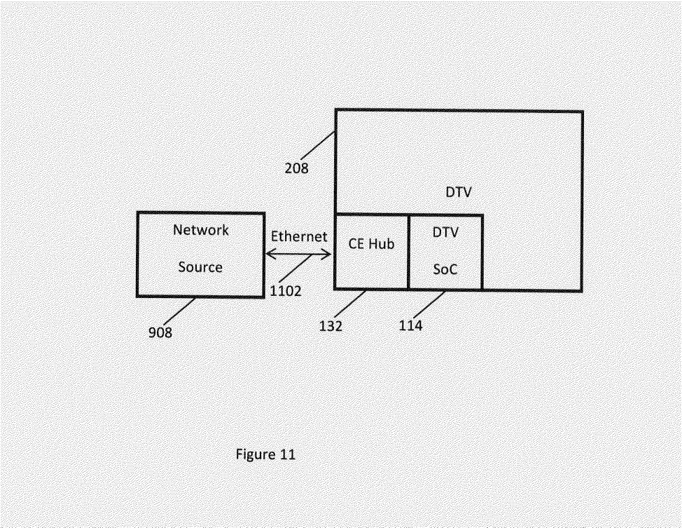

FIG. 11 is a system diagram which illustrates a DTV Pre-fetch system. The DTV 208 is coupled via an Ethernet cable 1102 to the network source 908.

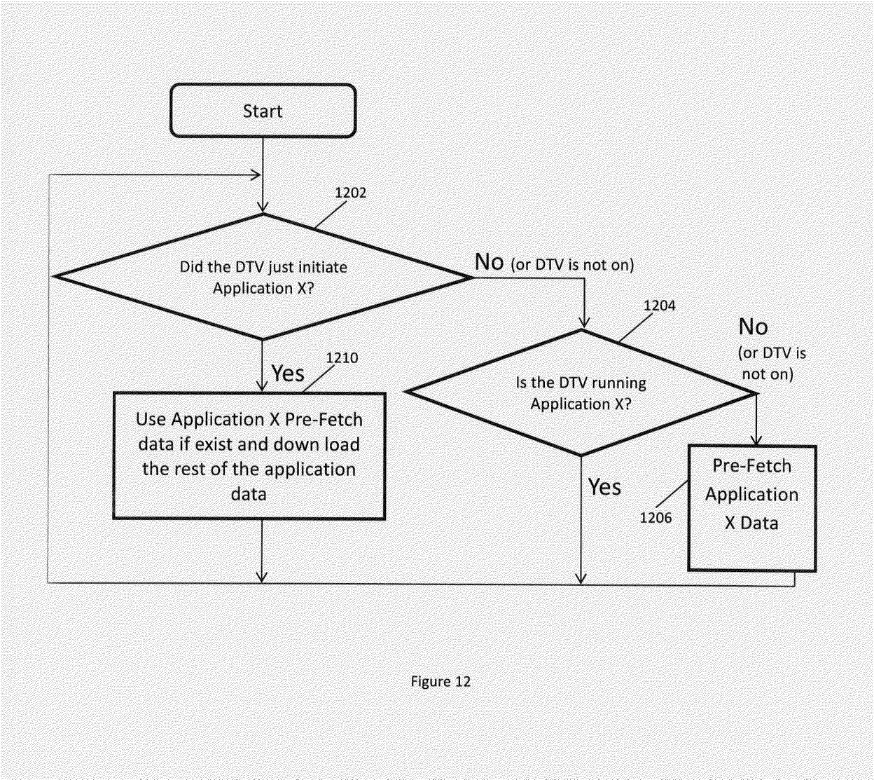

FIG. 12 is a flowchart which illustrates utilizing the DTV 208 in a Pre-fetch mode. Referring to FIGS. 11 and 12 together, first it is determined if the DTV 208 has initiated Application X, via step 1202. If the application is not initiated or the DTV 208 is off running Application X, it is determined if the DTV 208 running Application X, via step 1204. If the DTV is not on, then application X data is prefetched, via step 1206 and return. If the DTV is running the application X, then return. On the other hand, if the DTV 208 has initiated Application X, via step 1202, then Application X Pre-Fetch data is used it exists and the rest of the application data is downloaded, via step 1210.

An example of an implementation of this prefetch feature is a suggested channel list based on network information. A database with a real time and/or off line information about suggested channels/movies to watch is constantly being pre-fetched to the DTV. When the user turns on the DTV he can immediately obtain a list of the suggested channels together with the regular channel list. A suggested list of movies can provide a link to the right Video-On-Demand service whose video was partially pre-fetched too.

### Advantages

The system and method in accordance with the present invention has several advantages which are detailed below.

1. (Increased wireless network coverage) There is an access point on the consumer electronics system that can run even if the consumer electronics system is in stand-by mode, which increases wireless network coverage.

2. (Increased wireless network coverage) By offering Wi-Fi Direct on the consumer electronics system that can run even if the consumer electronics system is in stand-by mode, increases the wireless network coverage.

3. (Advanced wake up) The consumer electronics system Wakes Up from stand-by when an application is present or available with the appropriate consumer electronics system configuration.

4. (Advanced wake up) The consumer electronics system Wakes Up from stand-by to switch to the Wireless Display in the specific mode that is required.

5. (Enhanced home networking) The consumer electronics system attached storage is available for access from the network even if the consumer electronics system in stand-by mode.

6. (Enhanced home networking) The Ethernet switch is located on the consumer electronics system, and is operable even if the consumer electronics system is in stand-by mode.

7. (Pre-Fetch network capability) Pre-Fetch network data/Internet application data is immediately available for the consumer electronics system to have access to at power on.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A consumer electronics system comprising:
a consumer electronics system on a chip (SoC); and
a networking chip integrated with the consumer electronics SoC, wherein the consumer electronics system can act as an access point (AP) to provide additional functionality.

2. The consumer electronics system of claim 1 wherein the consumer electronics SoC comprises a digital television (DTV) SoC.

3. The consumer electronics system of claim 1, wherein the networking chip and associated software comprises a consumer electronics (CE)-Hub.

4. The consumer electronics system of claim 1, wherein the consumer electronics system acts as an AP, regardless of the mode of operation of the DTV.

5. The consumer electronics system of claim 1, wherein the consumer electronics system acts as an AP by using a software access point (softAP) scheme with the consumer electronics SoC staying operational and not in standby mode.

6. A consumer electronics system comprising:
a consumer electronics system on a chip system-on-a-chip (SoC); and
a networking chip integrated with the consumer electronics SoC, wherein the consumer electronics system in standby mode provides fully functional wireless capabilities.

7. The consumer electronics system of claim 6 wherein the consumer electronics SoC comprises a digital television (DTV) SoC.

8. The consumer electronics system of claim 7, wherein the networking chip and associated software comprises a consumer electronics (CE)-Hub.

9. The consumer electronics system of claim 6, wherein the consumer electronics system has Wi-Fi Direct capabilities regardless of the mode of operation of the consumer electronics system.

10. The consumer electronics system of claim 6, wherein the consumer electronics system can wake up from a stand-by mode or other non-fully operational mode to a specific consumer electronics mode upon network application update.

11. The consumer electronics system of claim 6, wherein the consumer electronics system can wake up from a stand-by mode or other non-fully operational mode to a specific consumer electronics system mode upon wireless display request.

12. A consumer electronics system comprising:
a consumer electronics system on a chip system-on-a-chip (SoC); and
a networking chip integrated with the consumer electronics SoC, wherein the consumer electronics system in standby mode provides fully functional wired switching capability.

13. The consumer electronics system of claim 12, wherein the consumer electronics SoC comprises a digital television (DTV) SoC.

14. The consumer electronics system of claim 13, wherein the networking chip and associated software comprises a consumer electronics (CE)-Hub.

15. The consumer electronics system of claim 12, wherein the consumer electronics system can provide access to its storage device regardless of the mode of operation of the consumer electronics system.

16. The consumer electronics system of claim 12, wherein the consumer electronics system can provide Ethernet switch or router capabilities regardless of the mode of operation of the consumer electronics system.

17. The consumer electronics system of claim 12, wherein the consumer electronics system can pre-fetch data for network application regardless of the mode of operation of the consumer electronics system.

18. The consumer electronics system of claim 14, wherein the CE-Hub helps to provide capabilities while the DTV SoC is in stand-by mode or other non-fully operational mode.

19. A digital television (DTV) system comprising:
a DTV system-on-a-chip (SoC); and
a consumer electronics (CE) Hub integrated with the DTV SoC, wherein the DTV system can act as an access point (AP) to provide additional functionality; wherein the DTV system has Wi-Fi Direct capabilities regardless of the mode of operation of the DTV system; wherein the DTV system can wake up from a stand-by mode or other non-fully operational mode to a specific DTV mode upon network application update; wherein the DTV can wake up from a stand-by mode or other non-fully operational mode to a specific DTV system mode upon wireless display request; wherein the DTV system can provide access to its storage device regardless of the mode of operation of the DTV system; wherein the DTV system can provide Ethernet switch capabilities regardless of the mode of operation of the DTV system; wherein the DTV system can pre-fetch data for network application regardless of the mode of operation of the DTV system.
